(19) United States
(12) Patent Application Publication
(10) Pub. No.: US 2018/0364425 A1
(43) Pub. Date: Dec. 20, 2018

(54) OPTICAL COMPONENT, OPTICAL DEVICE, AND METHOD OF MANUFACTURING OPTICAL COMPONENT

(71) Applicant: SUMITOMO ELECTRIC INDUSTRIES, LTD., Osaka (JP)

(72) Inventors: Takuya NANJO, Osaka (JP); Tetsuya NAKANISHI, Osaka (JP)

(73) Assignee: SUMITOMO ELECTRIC INDUSTRIES, LTD., Osaka (JP)

(21) Appl. No.: 16/007,253

(22) Filed: Jun. 13, 2018

(30) Foreign Application Priority Data
Jun. 16, 2017 (JP) 2017-118542

(51) Int. Cl. G02B 6/38

(52) U.S. Cl. CPC G02B 6/3885; G02B 6/3839; G02B 6/3829; G02B 6/3822

(57) ABSTRACT

To provide an optical component that is intended to prevent the reduction in the manufacturing yield that may be caused by excessive grinding of the optical component. An optical component includes a plurality of optical fibers arranged in a row and having respective end faces that are inclined with respect to optical axes of the optical fibers, and a holder that holds the plurality of optical fibers. The holder has a first facet that is flush with the end faces of the plurality of optical fibers, a reflecting film that covers the end faces of the plurality of optical fibers excluding at least one end face, and a second facet that forms a transmitting surface for light reflected by one of or both a corresponding one of the covered end faces and the reflecting film.

### BACKGROUND OF THE INVENTION

### Field of the Invention

The present invention relates to an optical component, an optical device to which an optical component is connected, and a method of manufacturing an optical component.

### Description of the Related Art

In recent years, various considerations regarding optical components that connect optical fibers to optical devices have been made for reducing the height of the optical devices. According to an exemplary proposal for an optical component, an optical fiber extending substantially parallel to a chip surface provided with a waveguide has an end face that is inclined with respect to the optical axis thereof, and light is reflected by the inclined end face, whereby the optical fiber is optically coupled to a grating coupler provided on the chip surface (see Japanese Unexamined Patent Application Publication No. 2016-194658 and European Patent Application Publication No. 2808713, for example). In a technique disclosed by Japanese Unexamined Patent Application Publication No. 2016-194658, the deterioration or elimination of the reflection characteristic at an end face of an optical fiber is prevented by a protective film that is pasted on the end face.

### SUMMARY OF THE INVENTION

It is an object of the present invention to provide an optical component, an optical device, and a method of manufacturing an optical component that are intended to prevent the reduction in the manufacturing yield of the optical component.

According to a first aspect of the present invention, there is provided an optical component including a plurality of optical fibers arranged in a row and having respective end faces that are inclined with respect to optical axes of the optical fibers, and a holder that holds the plurality of optical fibers. The holder has a first facet that is flush with the end faces of the plurality of optical fibers, a reflecting film that covers the end faces of the plurality of optical fibers excluding at least one end face, and a second facet that forms a transmitting surface for light reflected by one of or both a corresponding one of the covered end faces and the reflecting film.

In the optical device according to the above aspect of the invention, the at least one end face may be the end face of one of the plurality of optical fibers that is at a side end (at the most outside) of the row. Furthermore, the reflecting film may include a metal film. Furthermore, the holder may include a grooved substrate having a plurality of grooves that are arranged in a row and position the plurality of optical fibers, respectively, and a lid member that holds the plurality of optical fibers such that the optical fibers are held between the grooved substrate and the lid member.

According to a second aspect of the present invention, there is provided an optical device including the optical component according to the first aspect of the invention, and an optical coupling device. A distance between the optical coupling device and a center of a core of one of the optical fibers that has the end face to be optically coupled to the optical coupling device is 55 μm or shorter.

According to a third aspect of the present invention, there is provided a method of manufacturing an optical component. The method includes a holding step of holding a plurality of optical fibers that are arranged in a row in a holder; a first-facet-forming step of cutting the holder that holds the plurality of optical fibers along a plane that is inclined with respect to optical axes of the plurality of optical fibers so as to form a first facet that contains the end faces of the plurality of optical fibers and extends in the plane; a reflecting-film-placing step of placing a reflecting film over the end faces of the plurality of optical fibers excluding at least one end face; and a second-facet-forming step of forming, in the holder, a second facet serving as a transmitting surface for light reflected by one of or both a corresponding one of the covered end faces and the reflecting film.

In the method according to the third aspect of the invention, the second-facet-forming step may include grinding a portion of the reflecting film, a portion of the holder, and a portion of each of claddings of the plurality of optical fibers.

According to the above aspects of the present invention, the cores can be prevented from being accidentally ground in the grinding performed for forming the second facet, and the reduction in the manufacturing yield of the optical component can be prevented. Furthermore, since the positions of the cores at the end faces of the optical fibers can be identified with reference to the position of the end of the core at the end face of the optical fiber that is not covered by the reflecting film, the optical component can be positioned relative to an optical module more accurately than in the related-art techniques.

### BRIEF DESCRIPTION OF THE DRAWINGS

FIG. 1 is a perspective view of an optical component according to a first embodiment of the present invention.

FIG. 2 is a side view of the optical component illustrated in FIG. 1.

FIG. 3 is a sectional view of the optical component illustrated in FIG. 1.

FIG. 4A is a front view of the optical component illustrated in FIG. 1.

FIG. 4B is a front view of an optical component according to a modification of the first embodiment of the present invention.

FIG. 5 illustrates a step of manufacturing the optical component according to the first embodiment of the present invention.

FIG. 6 also illustrates the step of manufacturing the optical component according to the first embodiment of the present invention.

FIG. 7 illustrates another step of manufacturing the optical component according to the first embodiment of the present invention.

FIG. 8 illustrates yet another step of manufacturing the optical component according to the first embodiment of the present invention.

FIG. 9 illustrates yet another step of manufacturing the optical component according to the first embodiment of the present invention.

FIG. 10 illustrates yet another step of manufacturing the optical component according to the first embodiment of the present invention.

FIG. 11 illustrates yet another step of manufacturing the optical component according to the first embodiment of the present invention.

FIG. 12 illustrates yet another step of manufacturing the optical component according to the first embodiment of the present invention.

FIGS. 13A, 13B, and 13C each illustrate yet another step of manufacturing the optical component according to the first embodiment of the present invention.

FIG. 14 illustrates an optical device according to a second embodiment of the present invention including an optical component and an optical module that are positioned face to face.

FIG. 15 is a side view of the optical device according to the second embodiment of the present invention.

### DESCRIPTION OF THE PREFERRED EMBODIMENTS

An optical component, an optical device, and a method of manufacturing an optical component according to specific embodiments of the present invention will now be described with reference to the accompanying drawings. The present invention is not limited to the following embodiments. It is intended that the scope of the present invention be defined by the appended claims and includes all equivalents to the claims and all changes made to the claims within the scope thereof.

If a protective film is pasted on an end face of an optical fiber, it becomes difficult or impossible to visually recognize the position of the core of the optical fiber through the protective film. Therefore, if a transmitting surface from which light propagated in the optical fiber and then reflected by the end face is emitted or a transmitting surface on which light yet to be propagated in the optical fiber but reflected by the end face is incident is formed by grinding performed in a direction substantially parallel to the core of the optical fiber, the possibility that the core may be accidentally damaged cannot be eliminated. Consequently, the manufacturing yield of the optical component is reduced. The present invention has been conceived in view of the above circumstances. An object of the present invention is to provide an optical component, an optical device, and a method of manufacturing an optical component that are intended to prevent the reduction in the manufacturing yield of the optical component.

### First Embodiment

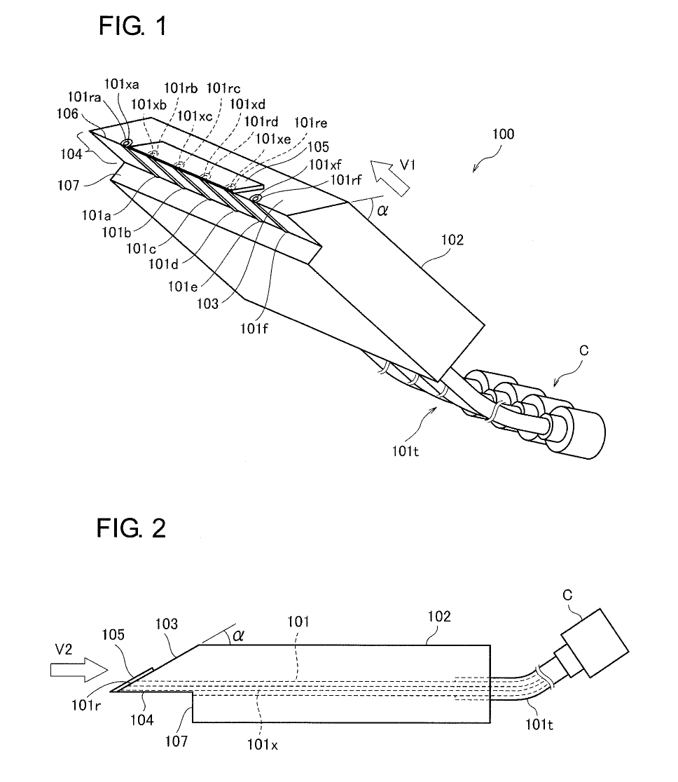

FIG. 1 is a perspective view of an optical component 100 according to a first embodiment. The optical component 100 includes a plurality of optical fibers 101t and a holder 102. A portion of each of the optical fibers 101t that extends outside the holder 102 may be provided with a covering.

The holder 102 holds a plurality of optical fibers 101 that are not provided with coverings and include distal portions of the optical fibers 101t in an aligned state. For example, the plurality of optical fibers 101 are arranged in a row with the respective optical axes extending substantially parallel to one another in one reference plane in the holder 102. If a row of three or more optical fibers 101 is held by the holder 102, it is preferable that the optical fibers 101 be arranged at regular intervals or at intervals each being defined as the arrangement pitch thereof multiplied by any natural number of 2 or greater. If the optical fibers 101 are arranged at regular intervals or at intervals each being defined as the arrangement pitch thereof multiplied by any natural number of 2 or greater, the positions of cores 101x of all optical fibers 101 can be easily identified by identifying the position of the core 101x of at least one of the optical fibers 101. Herein, reference numeral 101x is used to refer to any of the cores (101xa, 101xb, 101xc, 101xd, 101xe, and 101xf) whose ends are illustrated in FIG. 1 or to generally refer to all of the cores.

In FIG. 1, for example, a row of six optical fibers 101 is held by the holder 102. On a first facet 103 of the holder 102, ends of the cores 101xa and 101xf of the two optical fibers 101 at the respective side ends of the row of six optical fibers 101 and claddings 101a and 101f surrounding the respective cores 101xa and 101xf are visible. The first facet 103 is flash with end faces 101ra and 101rf formed of the cores 101xa and 101xf and the claddings 101a and 101f provided therearound.

In FIG. 1, for example, end faces (101rb, 101rc, 101rd, and 101re) formed of ends of the cores (101xb, 101xc, 101xd, and 101xe) of four of the six optical fibers 101 excluding the two at the side ends of the row and claddings (101b, 101c, 101d, and 101e) provided therearound are illustrated by dotted lines on the first facet 103. The illustration by the dotted lines means that the end faces (101rb, 101rc, 101rd, and 101re) are covered by a reflecting film 105 and are therefore difficult or impossible to visually recognize through the reflecting film 105.

The reflecting film 105 changes the direction of propagation of light in each of the cores 101x. The reflecting film 105 includes, for example, a metal film made of gold (Au), aluminum (Al), or the like. The metal film changes the direction of propagation of light in each of the cores 101x. Since the reflecting film 105 includes the metal film, the direction of light propagation can be changed more assuredly even if the grinding of the end faces (101rb, 101rc, 101rd, and 101re) is insufficient. To protect the metal film from deterioration, the metal film may be provided between a glass (such as silica glass) film and a silicon-dioxide film. For example, the reflecting film 105 may be obtained by forming a metal film on a glass film through metal vapor deposition and depositing silicon dioxide thereon.

If the reflecting film 105 is formed of a material having a lower refractive index than the material forming the cores 101x so that the angle at which light propagated in each of the cores 101x is incident on a corresponding one of the end faces (101rb, 101rc, 101rd, and 101re) becomes the critical angle or greater, the reflecting film 105 can cause the total internal reflection. The critical angle is determined by the refractive index of the material forming the cores 101x and the refractive index of the material forming the reflecting film 105.

The first facet 103, a second facet 104, and a third facet 107 of the holder 102 each form one flat surface. Specifically, the end faces 101ra and 101rf and the end faces (101rb, 101rc, 101rd, and 101re) covered by the reflecting film 105 that are present on the first facet 103 are flush with the first facet 103. The claddings (101a, 101b, 101c, 101d, 101e, and 101f) of the six optical fibers 101 are exposed on the second facet 104 and on the third facet 107 and are flush with each of the second facet 104 and the third facet 107.

Denoting a portion of the holder 102 where the first facet 103, the second facet 104, and the third facet 107 are present as “the front portion” of the holder 102 and a portion opposite the front portion as “the rear portion” of the holder 102, the plurality of optical fibers 101 arranged in a row in the holder 102 each extend through the holder 102 in a portion between the front portion and the rear portion. In the state illustrated in FIG. 1, the four optical fibers 101 whose end faces are covered by the reflecting film 105 are denoted as the optical fibers 101t provided with the coverings and extend from the rear portion of the holder 102, with the other ends thereof being connected to connectors C. The other optical fibers 101 whose end faces are not covered by the reflecting film 105 may also be connected at the other ends thereof to connectors C and be denoted as optical fibers 101t. Moreover, only some of the four optical fibers 101t whose end faces are covered by the reflecting film 105 may be connected at the other ends thereof to the connectors C.

Referring to FIG. 1, the end faces (101ra, 101rb, 101rc, 101rd, 101re, and 101rf) that are present in the front portion of the holder 102 are flush with the first facet 103. Therefore, when the optical component 100 is seen in a direction V1 in which the optical fibers 101 are arranged in a row (in other words, a direction in which a connection line 106 between the first facet 103 and the second facet 104 extends), the end faces (101ra, 101rb, 101rc, 101rd, 101re, and 101rf) of the optical fibers 101 are all inclined with respect to the optical axes of the optical fibers 101 by a uniform angle α. If the top surface of the holder 102 that is hidden in FIG. 1 is parallel to the above-mentioned reference plane, the angle α corresponds to an angle formed between the first facet 103 and the top surface of the holder 102.

FIG. 2 is a side view of the optical component 100 illustrated in FIG. 1 that is seen in the direction V1. It may be difficult to observe the optical fibers 101 from a side of the holder 102. Therefore, in FIG. 2, the portions of the optical fibers 101 extending in the holder 102 are illustrated by dotted lines, and the cores of the optical fibers 101 are generally denoted by reference numeral 101x. The first facet 103 is inclined with respect to the optical axes of the optical fibers 101 by the angle α. Accordingly, the end faces 101r containing the ends of the cores 101x of the optical fibers 101 are also inclined with respect to the optical axes of the respective optical fibers 101 by the angle α. Hence, light propagated in each of the cores 101x of the optical fibers 101 is incident on a corresponding one of the end faces 101r at an angle expressed as 90°−α. Note that reference numeral 101r denotes any of the end faces (101ra, 101rb, 101rc, 101rd, 101re, and 101a) or generally denotes the end faces (101ra, 101rb, 101rc, 101rd, 101re, and 101rf).

For example, regarding the cores 101xa and 101xf, if the incident angle of 90°−α on the respective end faces 101ra and 101rf is greater than or equal to the critical angle that is determined by the refractive index of the cores 101xa and 101xf and the refractive index of the air, the light incident on each of the end faces 101ra and 101rf undergoes total internal reflection, travels through a corresponding one of the claddings 101a and 101f of the optical fibers 101, and is emitted from the second facet 104 to the outside of the holder 102. Light is characterized in that the path of propagation does not change even if the direction of propagation is reversed. Therefore, when light traveling from the side of the second facet 104 through each of the claddings 101a and 101f and caused to undergo total internal reflection by a corresponding one of the end faces 101ra and 101rf is redirected to travel in the direction parallel to the optical axis of a corresponding one of the optical fibers 101 and enters a corresponding one of the cores 101xa and 101xf, the light is propagated in the corresponding core 101xa or 101xf toward the rear portion of the holder 102.

Focusing now on the end faces 101r that are covered by the reflecting film 105, suppose that the refractive index of the material forming the reflecting film 105 at the connection to the cores 101x is lower than the refractive index of the material forming the cores 101x. In such a case, if the incident angle (90°−α) at which the light propagated in each of the cores 101x is incident on a corresponding one of the end faces 101r is the critical angle or greater, the light undergoes total internal reflection. The light having undergone total internal reflection is transmitted through a corresponding one of the claddings and is emitted from the second facet 104 to the outside of the holder 102. If the reflecting film 105 includes a metal film, the light is reflected by the metal film even without undergoing total internal reflection at the end face 101r. Therefore, the light propagated in the core 101x is transmitted through the second facet 104. On the other hand, when light that enters each of the claddings of the optical fibers 101 from the second facet 104 and is caused to undergo total internal reflection by the end face 101r or is reflected by the reflecting film 105 to be redirected to travel in the direction of the optical axis of the optical fiber 101 enters a corresponding one of the cores 101x, the light is propagated in the core 101x toward a corresponding one of the connectors C.

That is, the second facet 104 serves as a transmitting surface for the light reflected by at least one of the end face 101r of the optical fiber 101 and the reflecting film 105. If the refractive index of adhesive that fixes the reflecting film 105 to the first facet 103 is set to a value higher than the refractive index of the core 101x, light can be controlled to be reflected not by the end face 101r but by the metal film included in the reflecting film 105. Even if the reflecting film 105 does not include the metal film, total internal reflection at the end face 101r can be caused by setting the refractive index of the adhesive for fixing the reflecting film 105 to the first facet 103 to a value lower than the refractive index of the core 101x. Moreover, even if the refractive index of the adhesive is higher than the refractive index of the core 101x, total internal reflection can be caused by the reflecting film 105 by setting the refractive index of the material forming the reflecting film 105 to a value lower than the refractive index of the adhesive.

The second facet 104 illustrated in FIG. 2 is a surface that is parallel to the optical axes of the optical fibers 101. However, the second facet 104 does not necessarily need to be parallel to the optical axes of the optical fibers 101 and may be inclined with respect to the optical axes of the optical fibers 101 depending on, for example, restrictions associated with the connection to an optical module or the like.

The third facet 107 illustrated in FIG. 2 extends substantially perpendicularly to the second facet 104. The third facet 107 can be formed when the second facet 104 is formed by grinding with a tool such as a dicer. The third facet 107 may be at any angle with respect to the second facet 104. Depending on the grinding performed for forming the second facet 104 and polishing performed after the grinding, the third facet 107 may be omitted (see FIG. 12, for example, to be referred to below).

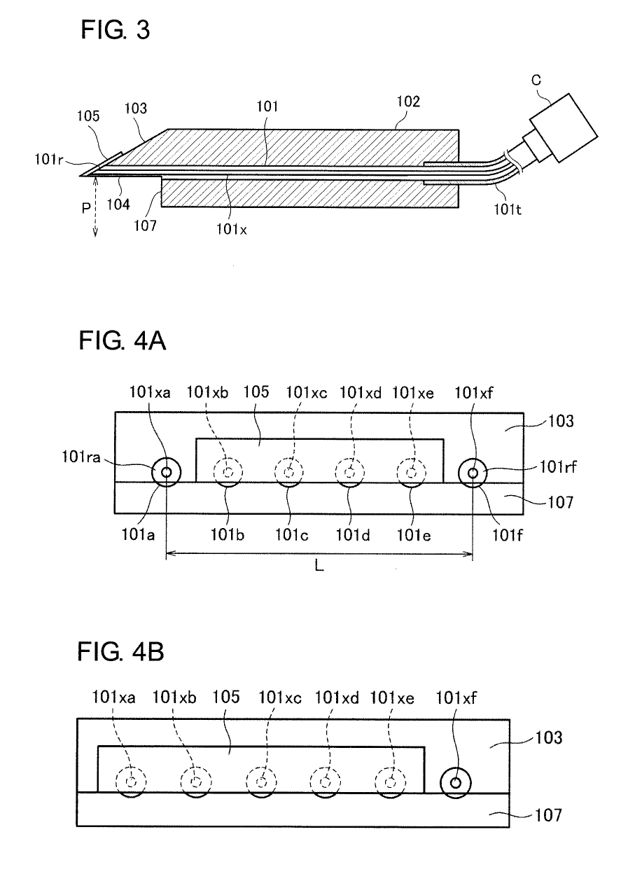

FIG. 3 illustrates an exemplary section of the optical component 100 that is taken along a plane perpendicular to the direction V1 (see FIG. 1) and extending through one of the cores 101x of the optical fibers 101. In FIG. 3, the optical fibers 101 and the cores 101x thereof illustrated by dotted lines in FIG. 2 are illustrated by solid lines. Reflection occurs at one of or both the intersection of each of the cores 101x and a corresponding one of the end faces 101r and the intersection of the optical axis of each of the cores 101x and the reflecting film 105, whereby light P propagated by the core 101x of the optical fiber 101 is redirected. For example, if the angle formed between the optical axis and the end face 101r is 45 degrees, the light P propagated in the core 101x is redirected perpendicularly by one of or both the end face 101r and the reflecting film 105.

Hence, if an optical coupling device, such as a grating coupler, for transmitting and receiving light is positioned below the intersection of the core 101x and the end face 101r or the intersection of the optical axis of the core 101x and the reflecting film 105, the optical coupling device and the optical fiber 101 can be optically coupled to each other. In such a case, the thickness of the optical component 100 (the length of the holder 102 in the vertical direction in FIGS. 2 and 3) can be reduced. That is, the height of the optical component 100 can be reduced.

FIG. 4A is a front view of the optical component 100 seen in a direction V2 (see FIG. 2) in which the optical axes of the optical fibers 101 extend. If the second facet 104 is parallel to the optical axes, the second facet 104 is not visible in FIG. 4A, with the first facet 103 of the holder 102 being illustrated on the upper side and with the third facet 107 being illustrated on the lower side.

The claddings 101a, 101b, 101c, 101d, 101e, and 101f of the optical fibers 101 are exposed on the third facet 107. That is, when the second facet 104 is formed by grinding with a tool such as a dicer and, if necessary, by polishing performed after the grinding, the claddings (101a, 101b, 101c, 101d, 101e, and 1010 of the optical fibers 101 are also ground and polished. If the claddings (101a, 101b, 101c, 101d, 101e, and 1010 are ground and polished, the distance between each of the cores 101x and the optical coupling device, strictly speaking, the distance between the intersection of each of the cores 101x and a corresponding one of the end faces 101r or the intersection of the optical axis of the core 101x and the reflecting film 105 (the position where the light propagated in the core 101x is reflected) and the optical coupling device can be reduced.

In particular, if the above distance is set to 55 μm or shorter, the optical coupling loss can be reduced to 0.5 dB or smaller as disclosed by European Patent Application Publication No. 2808713. Therefore, a typical requirement for the upper limit of the optical coupling loss that is imposed on the optical component 100 can be satisfied. Moreover, if the distance is set to 10 μm or shorter, the optical coupling loss can be reduced to substantially zero.

The reflecting film 105 provided on the first facet 103 covers the end faces 101r of the optical fibers 101 excluding the end faces 101ra and 101rf (see FIGS. 2 and 3). As described above, the covered end faces 101r of the optical fibers 101 are difficult or impossible to visually recognize through the reflecting film 105. Therefore, when the covered optical fibers 101 are optically coupled to the optical coupling device, the optical component 100 may be positioned with respect to the optical component 100 by moving the optical component 100 while observing signals outputted from the connectors C or signals outputted from the optical coupling device, and finding the position where the signal outputs become highest. However, such a method takes time and is difficult to control because the diameter of each of the cores 101x and the size of the optical coupling device such as a grating coupler are in the order of micrometers, and the position of the holder 102 of the optical component 100 needs to be controlled in the order of submicrometers.

In contrast, according to the first embodiment, the optical fibers 101 having the end faces 101ra and 101rf that are not covered by the reflecting film 105 are observable. Therefore, on the basis of the positions of the cores 101xa and 101xf thus observed, the positions of the cores 101xb, 101xc, 101xd, and 101xe that are covered by the reflecting film 105 can be identified.

Specifically, an interval L between the cores 101xa and 101xf observable at the end faces 101ra and 101rf is first measured, and the positions of the cores 101xb, 101xc, 101xd, and 101xe of the covered optical fibers 101 are identified on the basis of the interval L and the positions of the cores 101xa and 101xf. For example, in the case where a row of six optical fibers 101 arranged at regular intervals are held by the holder 102, there are five intervals among the six optical fibers 101. Therefore, it can be identified that the cores 101xb, 101xc, 101xd, and 101xe are positioned at respective distances of L/5, (2*L)/5, (3*L)/5, and (4*L)/5 from the core 101xa in that order toward the right side in FIG. 4A on a virtual line connecting the core 101xa and the core 101xf.

The number of end faces 101r that are not covered by the reflecting film 105 is not limited to two and may be one. For example, referring to FIG. 4B, if only an end face where the end of the core 101xf is present is not covered by the reflecting film 105, the positions of the ends of the covered cores 101xa, 101xb, 101xc, 101xd, and 101xe can be identified as follows.

The six optical fibers 101 are arranged in a row in the above-mentioned reference plane. Therefore, the ends of the covered cores 101x (the cores 101xa, 101xb, 101xc, 101xd, and 101xe) are positioned on a virtual straight line passing through the end of the core 101xf and being parallel to the reference plane. For example, if the reference plane and the top surface of the holder 102 are parallel to each other, the ends of the covered cores 101x are positioned on a virtual straight line passing through the end of the core 101xf and being parallel to the top surface of the holder 102. Furthermore, using the knowledge that the six optical fibers 101 are arranged in the reference plane and at regular intervals or at intervals each being defined as the arrangement pitch thereof multiplied by any natural number of 2 or greater, it can be identified that the covered cores 101x extend parallel to the top surface of the holder 102 and are positioned at respective distances each defined as the arrangement pitch of the optical fibers 101 multiplied by a natural number of 1 or greater from the position of the end of the core 101xf.

The end face 101r that is not covered by the reflecting film 105 does not necessarily need to be the end face 101r of the optical fiber 101 positioned at one of or each of both of the two side ends of the row of optical fibers 101 and may be the end face 101r of any optical fiber 101 excluding those at the two side ends of the row. However, if the end face 101r that is not covered by the reflecting film 105 is set to the end face 101ra or 101rf of the optical fiber 101 that is at a side end (at the most outside) of the row of optical fibers 101, the minimum number of reflecting films 105 required can be set to one, as long as the reflecting film 105 has a rectangular shape. Consequently, the cost of the optical component 100 can be reduced, and the process of fixing the reflecting film 105 to the first facet 103 can be simplified. Even if the end face 101r that is not covered by the reflecting film 105 is not at a side end (at the most outside) of the row of optical fibers 101, one reflecting film 105 having a recessed shape instead of a rectangular shape may be employed. However, a reflecting film 105 having such a less simple shape may increase the steps of forming the reflecting film 105.

If the end face 101r that is not covered by the reflecting film 105 is set to each of the end faces 101ra and 101rf at both side ends of the row of optical fibers 101, the minimum number of reflecting films 105 required is one. Moreover, the interval L can be set to a large value. Therefore, the positions of the ends of the cores (101xb, 101xc, 101xd, and 101xe) covered by the reflecting film 105 can be identified more accurately. Consequently, the optical component 100 can be positioned more accurately with respect to an optical device.

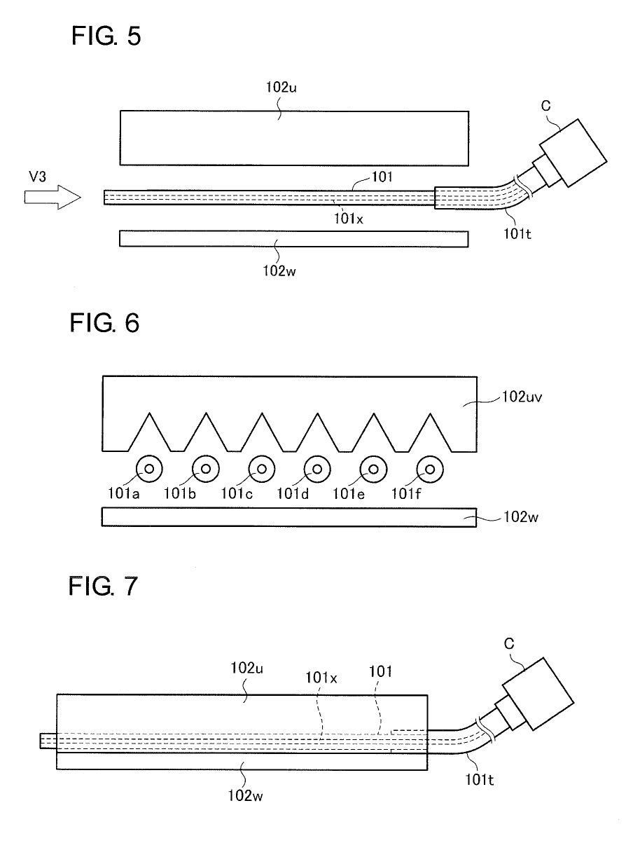

FIG. 5 is a side view illustrating a step of manufacturing the optical component 100. First, in a holding step, a plurality of optical fibers 101 that are arranged, for example, in a row at regular intervals in a direction perpendicular to a longitudinal direction V3 thereof are placed between a holder upper part 102u and a holder lower part 102w, and the optical fibers 101 and the holder upper and lower parts 102u and 102w are fixed altogether with adhesive or the like (if a plurality of optical fibers 101t provided with coverings are used, at least portions of the coverings on the side nearer to the end faces 101r are removed in advance). To arrange the optical fibers 101 at regular intervals in the direction perpendicular to the longitudinal direction V3, at least one of the holder upper part 102u and the holder lower part 102w may have grooves provided at regular intervals, so that the optical fibers 101 are fitted therein.

If the holder 102 includes such grooved substrates, the interval between adjacent ones of the plurality of optical fibers 101 can be made the same as the pitch of the grooves in the substrate or be set to the pitch of the grooves in the substrate multiplied by a natural number of 2 or greater. Thus, the positions of the cores 101x at the end faces 101r of the covered optical fibers 101 can be identified more accurately from the position of the end of the core 101x at the end face 101r of the optical fiber 101 that is not covered by the reflecting film 105. Consequently, the optical component 100 can be positioned more easily with respect to an optical module.

FIG. 6 also illustrates the holding step illustrated in FIG. 5 that is seen in the longitudinal direction V3 of the optical fiber 101. The example illustrated in FIG. 6 concerns a case where a V-grooved substrate 102uv having V-shaped grooves provided at regular intervals is employed as the holder upper part 102u. When the plurality of optical fibers 101 are fitted into the V-shaped grooves, a gap is produced between each of the optical fibers 101 and a corresponding one of the V-shaped grooves because the optical fiber 101 has a circular cross-sectional shape. Hence, adhesive is first provided into the V-shaped grooves so as to fill the gap, and the optical fibers 101 are fitted therein. Adhesive is also applied to the upper surface of the holder lower part 102w, and the holder lower part 102w is brought close to the V-grooved substrate 102uv such that the holder lower part 102w serves as a lid member, whereby the optical fibers 101 are held between the holder lower part 102w and the V-grooved substrate 102uv. Thus, the V-grooved substrate 102uv, the optical fibers 101, and the holder lower part 102w are fixed to one another. While the holder lower part 102w used as a lid member is a flat board in FIGS. 5 and 6, the holder lower part 102w may also have grooves, so that the optical fibers 101 are held between the grooves of the holder lower part 102w and the grooves of the holder upper part 102u, respectively.

FIG. 7 is a side view of the holder upper part 102u, the optical fibers 101, and the holder lower part 102w that are fixed to one another. The cores 101x of the optical fibers 101 are positioned in the holder upper part 102u, which is positioned above the holder lower part 102w. Where the cores 101x are positioned depends on the size of the grooves provided in the V-grooved substrate 102uv illustrated in FIG. 6, the presence/absence and the size of the grooves in the holder lower part 102w, and the diameter of the optical fibers 101. Therefore, depending on the situation, the cores 101x of the optical fibers 101 may be positioned in the holder lower part 102w.

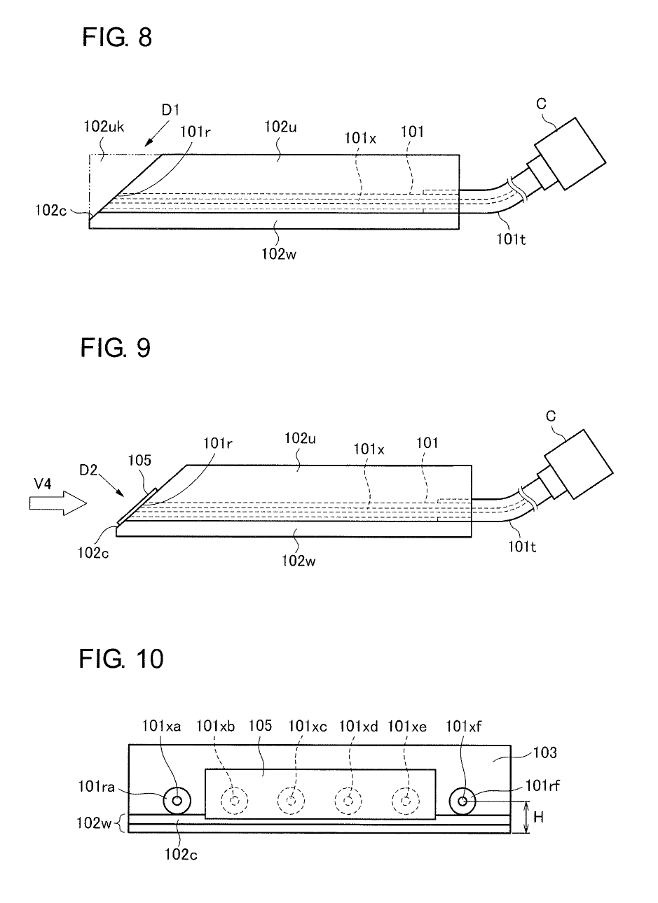

FIG. 8 illustrates an exemplary first-facet-forming step of forming the first facet 103 by grinding, in which the holder upper part 102u and, if necessary, the holder lower part 102w are cut in a direction D1 that is oblique with respect to the optical axes of the optical fibers 101, whereby a portion 102uk is removed. By removing the portion 102uk, the optical fibers 101 can have end faces 101r that are inclined with respect to the optical axes, and a flat surface extending in the direction D1 can be obtained as a first facet 103 containing the end faces 101r. Depending on the direction D1 and the size of the portion 102uk to be removed, a surface 102c as an extension of the flat surface may be formed in the holder lower part 102w as illustrated in FIG. 8. After the cutting step, the surface containing the first facet 103 may be polished so as to polish the end faces 101r.

FIG. 9 illustrates a reflecting-film-placing step in which a reflecting film 105 is placed on the surface, formed as above by removing the portion 102uk, in a direction D2 that is substantially perpendicular to the surface, and the reflecting film 105 is fixed thereto. The reflecting film 105 is placed over the end faces 101r of the plurality of optical fibers 101 excluding at least one end face 101r. The end face 101r that is not covered by the reflecting film 105 may be selected arbitrarily but is preferably the end face 101r of the optical fiber 101 at a side end (at the most outside) of the row of optical fibers 101, as described above.

The reflecting film 105 is provided for redirecting the light propagated in each of the cores 101x. Theoretically, when the end of the core 101x is covered, it does not necessarily need to cover the entirety of the end face 101r containing the core 101x. However, if the entirety of the end face 101r is covered by the reflecting film 105, the end face 101r is protected by the reflecting film 105 when grinding and, if necessary, polishing are performed for forming the second facet 104, with only a portion of the reflecting film 105 being ground. Therefore, the cladding at the end face 101r is prevented from being chipped. Accordingly, the core 101x is prevented from being affected by chipping. Consequently, the manufacturing yield of the optical component 100 is improved. In this respect, it is preferable that the reflecting film 105 cover the entirety of each of the end faces 101r and the boundary between the first facet 103 and the second facet 104 even after the first facet 103 and the second facet 104 are formed. Therefore, when the portion 102uk (see FIG. 8) is removed for forming the first facet 103, it is preferable to cut both the holder upper part 102u and the holder lower part 102w in the direction D1 in forming the surface 102c and to place the reflecting film 105 over a portion of the surface 102c. Depending on the function to be given to the reflecting film 105, the reflecting film 105 may be regarded as either a reflecting film or a protective reflecting film.

FIG. 10 is a front view of the optical component 100 with the reflecting film 105 fixed thereto, seen in an optical-axis direction V4 (see FIG. 9) of the optical fibers 101. In this state, the cores 101xa and 101xf of the end faces 101ra and 101rf of the optical fibers 101 that are not covered by the reflecting film 105 are observable. Therefore, the amount of grinding and the amount of polishing for forming the second facet 104 can be determined by measuring a distance H between the bottom surface of the holder lower part 102w and each of the cores 101xa and 101xf. The distance H varies with the thickness of the holder lower part 102w, which varies among individual products, and with the amount of adhesive provided between the holder lower part 102w and the holder upper part 102u. Therefore, if the amount of grinding and the amount of polishing for forming the second facet 104 are determined uniformly, the cores 101x may be ground and polished and may be damaged.

Even if the amount of grinding and the amount of polishing are not determined in advance on the basis the measurement of the distance H, when the second facet 104 is formed, how much the grinding or polishing has progressed can be observed with reference to the cores 101xa and 101xf. With the presence of the end face 101r that is not covered by the reflecting film 105, the cores 101x are prevented from being damaged during grinding and polishing, and the reduction in the manufacturing yield is prevented.

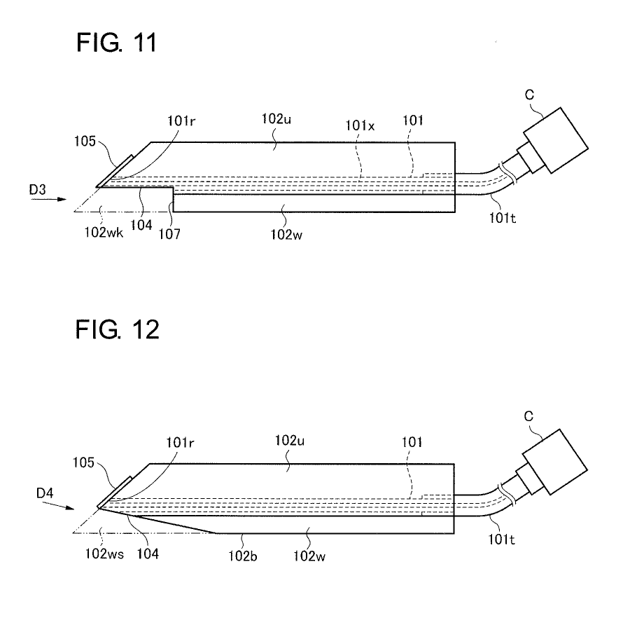

FIG. 11 illustrates a second-facet-forming step of forming the second facet 104 and, if necessary, the third facet 107, in which grinding and, if necessary, polishing are performed by advancing a dicer or the like in a direction D3 into the holder lower part 102w and, if necessary, into the holder upper part 102u, whereby a portion 102wk is removed. As described above, the reflecting film 105 is placed such that a portion of the reflecting film 105 is also ground and polished in this step. Therefore, the occurrence of chipping is prevented when the connection line 106 between the first facet 103 and the second facet 104 is ground and polished. Accordingly, the occurrence of damage to the cores 101x is prevented. Consequently, the reduction in the manufacturing yield is prevented.

FIG. 12 illustrates a modification in which the second facet 104 is formed in such a manner as to form no third facet. In FIG. 12, the second facet 104 is formed by grinding and polishing the holder upper part 102u and the holder lower part 102w obliquely with respect to the cores 101x. In this step, the third facet 107 is not formed. If the third facet 107 is formed as illustrated in FIG. 11, when the optical component 100 is connected to an optical module, a stress may be concentrated on the connection between the second facet 104 and the third facet 107. To avoid such a situation, as illustrated in FIG. 12 for example, a dicer or the like is made to advance for grinding and polishing obliquely in a direction D4 with respect to the cores 101x, whereby a portion 102ws is removed. Thus, no third facet is formed, and the local concentration of the stress is avoided.

In FIG. 10 and others, a plurality of end faces 101ra and 101rf are illustrated as the end faces 101r that are not covered by the reflecting film 105. Alternatively, as illustrated in FIG. 4B, the number of end faces 101r that are not covered by the reflecting film 105 may be only one, for example, only the end face 101rf.

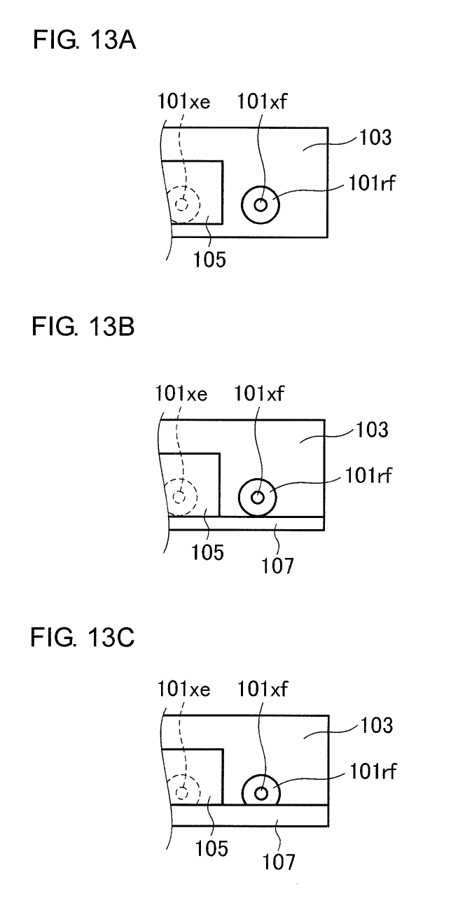

FIGS. 13A to 13C illustrate steps of forming the second facet 104 while observing the core 101xf. FIG. 13A illustrates an exemplary state where grinding and polishing for forming the second facet 104 are yet to be performed. In other words, FIG. 13A illustrates a state where the reflecting film 105 has been placed after the portion 102uk (see FIG. 8) has been removed.

FIG. 13B illustrates a state where grinding has been started from the bottom surface 102b (see FIG. 12) of the holder lower part 102w in a direction, for example, parallel to the bottom surface 102b, and the third facet 107 has been formed by grinding at the tip of the dicer. Since the end of the core 101xf is observable, the distance between the ground surface and the core 101xf can be measured for checking the progress of the grinding. Then, polishing can be performed.

FIG. 13C illustrates a state where the grinding and the polishing have progressed further than in FIG. 13B, the distance between the ground surface and the core 101xf has been reduced to a predetermined value or smaller, and the grinding and the polishing have been finished. Since the amount of grinding can be checked, accidental grinding and polishing of the cores 101x can be prevented.

### Second Embodiment

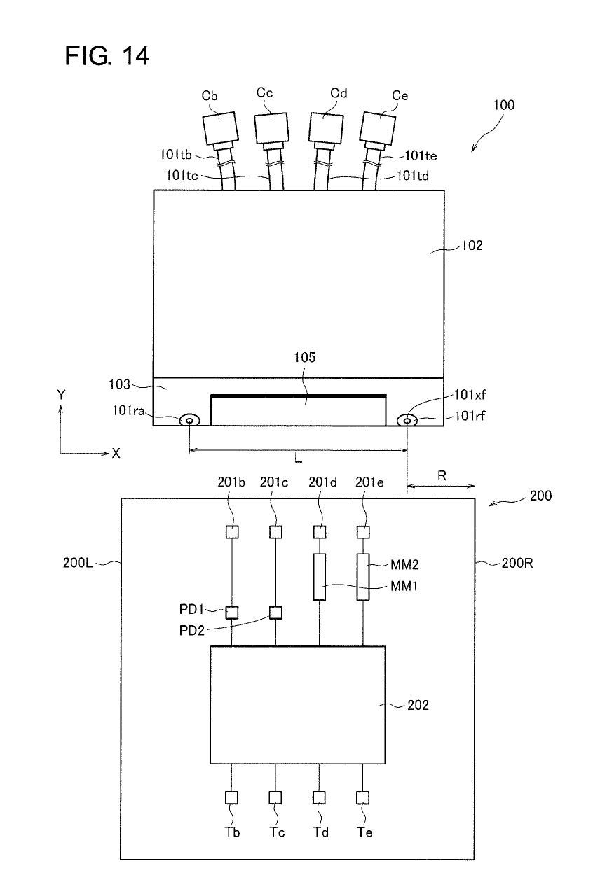

FIG. 14 illustrates how to connect the optical component 100 to a silicon photonics device 200 as an exemplary optical module. To connect the optical component 100 to the silicon photonics device 200, the first facet 103 of the optical component 100 is moved relative to and brought close to the silicon photonics device 200, and the second facet 104 is eventually positioned over optical coupling devices. The silicon photonics device 200 includes grating couplers (201b, 201c, 201d, and 201e), which are exemplary optical coupling devices, on a surface thereof and near the upper end, in FIG. 14, thereof. The grating couplers (201b, 201c, 201d, and 201e) are provided for inputting and outputting light into and from the optical fibers 101. The grating couplers (201b, 201c, 201d, and 201e) are arranged at the same intervals as the plurality of optical fibers 101 included in the optical component 100, so that the optical component 100 and the silicon photonics device 200 can be optically coupled to each other with the ends of the cores (101xb, 101xc, 101xd, and 101xe) at the end faces (101rb, 101re, 101rd, and 101re) that are covered by the reflecting film 105 being positioned on the grating couplers (201b, 201c, 201d, and 201e), respectively.

The grating couplers 201b and 201c receive optical signals propagated in the cores 101xb and 101xc, respectively, from the optical component 100. To do so, the grating couplers 201b and 201c are provided with photodiodes PD1 and PD2, which are each an exemplary device that converts an optical signal into an electric signal. The outputs from the photodiodes PD1 and PD2 are supplied to a signal processing circuit 202, and the resulting electric signals are outputted to terminals Tb and Tc, respectively. The grating couplers 201d and 201e cause optical signals to propagate into the cores 101xd and 101xe, respectively. To do so, the grating couplers 201d and 201e receive light outputted from Mach-Zehnder interferometric modulators MM1 and MM2, which are each an exemplary optical modulator circuit that modulates an optical signal, in accordance with optical signals resulting from electric signals inputted from terminals Td and Te, respectively, and processed by the signal processing circuit 202.

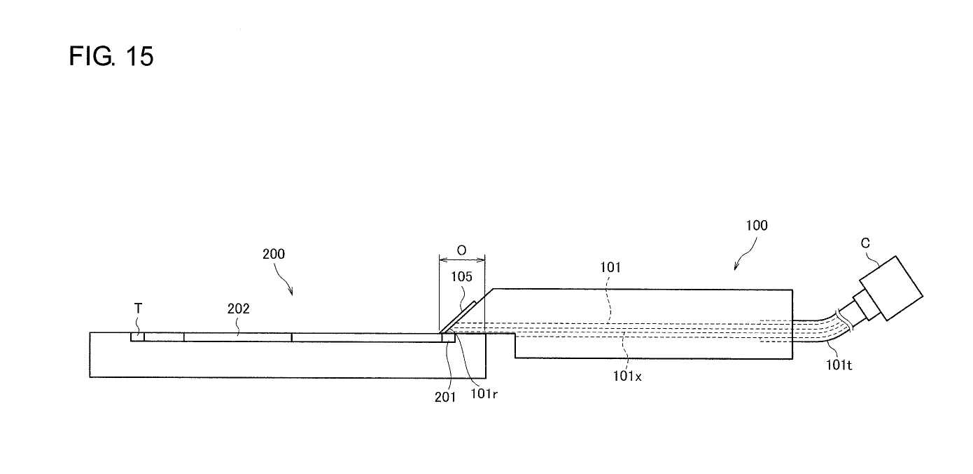

FIG. 15 is a side view of the optical component 100 whose optical fibers 101 are optically coupled to the silicon photonics device 200 with the ends of the cores (101xb, 101xc, 101xd, and 101xe) being positioned on the respective grating couplers (201b, 201c, 201d, and 201e). Light that is inputted into each of the connectors C and is propagated in a corresponding one of the cores 101x horizontally along the plane of the drawing is reflected by one of or both a corresponding one of the end faces 101r and the reflecting film 105 in such a manner as to be redirected by substantially 90 degrees. Then, the light enters the chip surface of the silicon photonics device 200 substantially perpendicularly and reaches a corresponding one of the grating couplers 201. The grating couplers 201 each redirect the received light by substantially 90 degrees so that the light travels horizontally along a corresponding one of waveguides provided in the substrate of the silicon photonics device 200, thereby inputting the light into the photodiodes PD.

On the other hand, light (not illustrated) outputted from each of the Mach-Zehnder interferometric modulators MM travels horizontally along a corresponding one of waveguides provided in the chip of the silicon photonics device 200 and reaches a corresponding one of the grating couplers 201. The grating couplers 201 each redirect the received light by substantially 90 degrees and emit the light substantially perpendicularly to the chip surface of the silicon photonics device 200. The light emitted from each of the grating couplers 201 is reflected by one of or both a corresponding one of the end faces 101r and the reflecting film 105 in such a manner as to be redirected by substantially 90 degrees, is propagated horizontally into the cores 101x, and is outputted from a corresponding one of the connectors C.

The light reflected by each of the end faces 101r or the reflecting film 105 in such a manner as to be redirected by substantially 90 degrees and being incident substantially perpendicularly on the chip surface of the silicon photonics device 200 and the light emitted from each of the grating couplers 201 are each diffused with a predetermined distribution such as a Gaussian distribution. Therefore, the shorter the distance between each of the grating couplers 201 and the end of a corresponding one of the cores 101x at the end faces 101r, the smaller the loss of light that may occur between the grating coupler 201 and the end of the core 101x. Hence, the optical component 100 according to the first embodiment employs the second facet 104, whereby the distance between the end of each of the cores 101x and a light-transmitting surface formed by the second facet 104 can be made, for example, smaller than 55 μm. Thus, the above loss of light can be reduced further. If any layer such as an adhesive layer or a layer for preventing diffuse reflection is provided between the optical component 100 and the grating couplers 201, the distance between the end of each of the cores 101x and the light-transmitting surface formed by the second facet 104 is set to, for example, smaller than 55 μm, considering the thickness of the adhesive layer or the layer for preventing diffuse reflection.

If the positions of the ends of the cores 101x are identified, the ends of the cores 101x can be positioned on the respective grating couplers 201. Specifically, as illustrated in FIG. 14, it is only necessary to identify the positions of the ends of the cores 101x at the end faces 101r in the X-axis direction in which the optical fibers 101 are arranged in a row and in the Y-axis direction in which the optical axis of each of the optical fibers 101 extends.

The positions of the cores 101x in the Y-axis direction can be identified by observing the cores 101x at the end faces 101r through the claddings (101a, 101b, 101c, 101d, 101e, and 101f) from the side of the optical component 100 on which the second facet 104 is formed. When the positions of the cores 101x in the Y-axis direction are identified, a length O by which the optical component 100 and the silicon photonics device 200 are made to overlap each other as illustrated in FIG. 15 can be obtained.

The positions of the cores 101x in the X-axis direction can be identified on the basis of the interval L between the ends of the cores 101xa and 101xf that are observable on the end faces 101ra and 101rf, as described above. Thus, for example, a length R illustrated in FIG. 14 from a right end 200R of the silicon photonics device 200 to the core 101xf at the end face 101rf can be obtained.

In a case where all of the cores 101x are difficult or impossible to visually recognize through the reflecting film 105, there is no way but to bring the optical component 100 and the silicon photonics device 200 close to each other, to input optical signals from the connectors Cb and Cc into the terminals Tb and Tc and electric signals into the terminals Td and Te, and to find the positions of the optical component 100 and the silicon photonics device 200 where the intensity of the electric signals outputted from the terminals Tb and Tc and the intensity of the optical signals received by the connectors Cd and Ce become highest. The diameters of the cores 101x of the optical fibers 101 and the sizes of the grating couplers 201 are each in the order of micrometers. Therefore, the optical component 100 and the silicon photonics device 200 need to be moved relative to each other in the order of submicrometers. Such work is very difficult to perform.

In contrast, according to the second embodiment of the present invention, since the positions of the ends of the cores 101x at the end faces 101r can be identified, the optical component 100 and the silicon photonics device 200 can be easily connected to each other by positioning the optical component 100 and the silicon photonics device 200 relative to each other with reference to the identified positions.

FIG. 14 is based on an assumption that the cores 101xa and 101xf are not optically coupled to anything when the optical component 100 and the silicon photonics device 200 are connected to each other. The present invention is not limited to such an embodiment. The silicon photonics device 200 may include grating couplers corresponding to the cores 101xa and 101xf so as to be optically coupled thereto. In that case, to prevent the deterioration or elimination of the reflection characteristic at the end faces 101ra and 101rf because of adhesion of any substance having a high refractive index to the ends of the cores 101xa and 101xf after the optical component 100 and the silicon photonics device 200 are connected to each other, the end faces 101ra and 101rf may be covered by a reflecting film that is the same as the reflecting film 105 after the optical component 100 and the silicon photonics device 200 are connected to each other.

What is claimed is:

1. An optical component comprising:
a plurality of optical fibers arranged in a row and having respective end faces that are inclined with respect to optical axes of the optical fibers; and
a holder that holds the plurality of optical fibers,
wherein the holder has
a first facet that is flush with the end faces of the plurality of optical fibers;
a reflecting film that covers the end faces of the plurality of optical fibers excluding at least one end face; and
a second facet that forms a transmitting surface for light reflected by one of or both a corresponding one of the covered end faces and the reflecting film.

2. The optical component according to claim 1, wherein
the at least one end face is the end face of one of the plurality of optical fibers that is at a most outside of the row.

3. The optical component according to claim 1, wherein
the reflecting film includes a metal film.

4. The optical component according to claim 2, wherein
the reflecting film includes a metal film.

5. The optical component according to claim 1,
wherein the holder includes
a grooved substrate having a plurality of grooves that are arranged in a row and position the plurality of optical fibers, respectively; and
a lid member that holds the plurality of optical fibers such that the optical fibers are held between the grooved substrate and the lid member.

6. The optical component according to claim 2,
wherein the holder includes
a grooved substrate having a plurality of grooves that are arranged in a row and position the plurality of optical fibers, respectively; and
a lid member that holds the plurality of optical fibers such that the optical fibers are held between the grooved substrate and the lid member.

7. The optical component according to claim 3,
wherein the holder includes
a grooved substrate having a plurality of grooves that are arranged in a row and position the plurality of optical fibers, respectively; and
a lid member that holds the plurality of optical fibers such that the optical fibers are held between the grooved substrate and the lid member.

8. The optical component according to claim 4,
wherein the holder includes
a grooved substrate having a plurality of grooves that are arranged in a row and position the plurality of optical fibers, respectively; and
a lid member that holds the plurality of optical fibers such that the optical fibers are held between the grooved substrate and the lid member.

9. An optical device comprising:
the optical component according to claim 1; and
an optical coupling device,
wherein a distance between the optical coupling device and a center of a core of one of the optical fibers that has the end face to be optically coupled to the optical coupling device is 55 μm or shorter.

10. A method of manufacturing an optical component, comprising:
a holding step of holding a plurality of optical fibers that are arranged in a row in a holder;
a first-facet-forming step of cutting the holder that holds the plurality of optical fibers along a plane that is inclined with respect to optical axes of the plurality of optical fibers so as to form a first facet that contains the end faces of the plurality of optical fibers and extends in the plane;
a reflecting-film-placing step of placing a reflecting film over the end faces of the plurality of optical fibers excluding at least one end face; and
a second-facet-forming step of forming, in the holder, a second facet serving as a transmitting surface for light reflected by one of or both a corresponding one of the covered end faces and the reflecting film.

11. The method according to claim 10, wherein
the second-facet-forming step includes grinding a portion of the reflecting film, a portion of the holder, and a portion of each of claddings of the plurality of optical fibers.
